(19) United States
(12) Patent Application Publication
(10) Pub. No.: US 2025/0061883 A1
(43) Pub. Date: Feb. 20, 2025

(54) PROBABILISTIC GENERATION OF SPEAKER DIARIZATION DATA

(71) Applicant: NVIDIA CORPORATION, Santa Clara, CA (US)

(72) Inventors: Tae Jin PARK, San Jose, CA (US); He HUANG, Greenville, SC (US); Jagadeesh BALAM, Campbell, CA (US)

(21) Appl. No.: 18/526,600

(22) Filed: Dec. 1, 2023

Related U.S. Application Data
(60) Provisional application No. 63/532,549, filed on Aug. 14, 2023.

(51) Int. Cl. G10L 13/02

(52) U.S. Cl. CPC G10L 13/02

(57) ABSTRACT

In various examples, a technique for generating a simulated multi-speaker recording includes determining a first rate at which a first speech-based attribute occurs within a first portion of the simulated multi-speaker recording. The technique also includes computing a first difference between the first rate and a first target rate for the first speech-based attribute. The technique further includes determining, based at least on the first difference, a second rate at which the first speech-based attribute is to occur within a second portion of the simulated multi-speaker recording and generating the second portion of the simulated multi-speaker recording based at least on the second rate.

### CLAIM OF PRIORITY

This application claims the benefit of U.S. Provisional Application No. 63/532,549 (Attorney Docket No. 23-SC-0623US01) titled “A Probabilistic Modeling Technique for Synthetic Data Generation,” filed Aug. 14, 2023, the entire contents of which is incorporated herein by reference.

### BACKGROUND

Speaker diarization refers to the process of partitioning an audio stream that includes recorded human speech into segments that are labeled with individual speakers. For example, a speaker diarization technique may be used to generate a transcript of an audio stream that captures the utterances of multiple speakers. Within the transcript, individual utterances may be annotated with the identities of the corresponding speakers and/or the corresponding start and end timestamps.

It may be difficult to acquire sufficient training data to train a machine learning model on a speaker diarization task. More specifically, a training dataset for a speaker diarization task should include audio streams that span a variety of speakers, varying number of speakers in each stream, acoustic conditions, and types of conversation. The training dataset should also include precise labels that specify start and end timestamps for each utterance and identify the speaker of the utterance. However, privacy concerns, data imbalances, limited availability of diverse audio data, and labeling overhead may interfere with the ability to collect real-world speech data that satisfies these requirements.

To overcome the limitations associated with collecting and annotating audio samples of real human dialogue, “multi-speaker” or “multi-talker” data simulators have been developed to generate synthetic speech data that may be used to train machine learning models on speaker diarization tasks. These multi-speaker data simulators typically mix pre-recorded audio clips labeled with speaker identities to mimic human dialogue. However, these multi-speaker data simulators often fail to capture essential characteristics of real human dialogue, such as overlapping speech and pauses. Consequently, machine learning models that are trained using synthetic data from these multi-speaker data simulators may perform poorly when tested on real-world data.

As such, a need exists for more effective techniques for improving the generation of training data for speaker diarization models and tasks.

### SUMMARY

Embodiments of the present disclosure relate to probabilistic generation of speaker diarization data for conversational artificial intelligence (AI) systems and applications. The techniques described herein for generating a simulated multi-speaker recording include determining a first rate at which a first speech-based attribute occurs within a first portion of the simulated multi-speaker recording. The technique also includes computing a first difference between the first rate and a first target rate for the first speech-based attribute. The technique further includes determining, based on the first difference, a second rate at which the first speech-based attribute is to occur within a second portion of the simulated multi-speaker recording and generating the second portion of the simulated multi-speaker recording based on the second rate.

One technical advantage of the disclosed techniques relative to prior approaches is the ability to generate a diverse and accurately labeled set of data for the purposes of training and/or evaluating a machine learning model on speaker diarization and/or related tasks. Accordingly, the disclosed techniques may be used to overcome issues with privacy, data imbalance, diversity, and labeling overhead associated with collecting real-world speaker diarization data. Another technical advantage of the disclosed techniques is the ability to generate multi-speaker audio data that adheres to specific distributions of speech overlap, silence, and/or other speech-based attributes. Consequently, the disclosed techniques may be used to generate synthetic speech data that mimics real human dialogue more accurately than conventional multi-speaker data simulators. In turn, machine learning models that are trained and/or tested using this synthetic speech data may perform better than conventional multi-speaker data simulators on speaker diarization, voice activity detection, and/or other tasks.

### BRIEF DESCRIPTION OF DRAWINGS

FIG. 1 illustrates a computing device configured to implement one or more aspects of various embodiments;

FIG. 2 illustrates a system for generating speaker diarization data that includes the processing engine and simulation engine of FIG. 1, according to various embodiments;

FIG. 3A illustrates the calculation of a silence discrepancy for a generated portion of a session within a simulated multi-speaker recording, according to various embodiments;

FIG. 3B illustrates the calculation of an overlap discrepancy for a generated portion of a session within a simulated multi-speaker recording, according to various embodiments;

FIG. 4A illustrates the calculation of a silence rate for a generated portion of a session within a simulated multi-speaker recording, according to various embodiments;

FIG. 4B illustrates the calculation of an overlap rate for a generated portion of a session within a simulated multi-speaker recording, according to various embodiments;

FIG. 5 illustrates a flow diagram of a method for generating a simulated multi-speaker recording, according to various embodiments;

FIG. 6 illustrates components of a distributed system that may be used to generate image or video content, according to various embodiments;

FIG. 7A illustrates inference and/or training logic, according to various embodiments;

FIG. 7B illustrates inference and/or training logic, according to various embodiments;

FIG. 8 illustrates an example data center system, according to various embodiments;

FIG. 9 illustrates a computer system, according to various embodiments;

FIG. 10 illustrates a computer system, according to various embodiments;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment; and

FIG. 14 is a system diagram for an example system for training, adapting, instantiating and deploying machine learning models in an advanced computing pipeline, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implementing one or more large language models (LLMs), systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

As discussed herein, it may be difficult to acquire sufficient training data to train (e.g., update one or more parameters—such as weights and biases—of a machine learning model over one or more iterations) a machine learning model on a speaker diarization task. While multi-speaker or multi-talker data simulators have been developed to generate synthetic speech data by mixing pre-recorded audio clips labeled with speaker identities to mimic human dialogues, these data simulators often fail to capture essential characteristics of real human dialogue, such as overlapping speech and pauses. Consequently, machine learning models that are trained using synthetic data from these multi-speaker data simulators may perform poorly when tested on real-world data.

To address the above limitations, the disclosed techniques use probabilistic models to control the generation of synthetic speech data that includes (i) multi-speaker audio recordings and (ii) labels that specify speaker identities and start and end timestamps for individual utterances within the multi-speaker audio recordings. The probabilistic models are used in conjunction with parameters that characterize the occurrences of various speech-based attributes within the synthetic speech data. For example, these parameters may be used to determine a distribution of overlapping speech, a distribution of silence, and/or other distributions of speech-based attributes in the multi-speaker audio recordings. During the generation of a given synthetic multi-speaker recording, a discrepancy between the rate at which a given speech-based attribute occurs within an existing generated portion of a multi-speaker audio recording and an expected or “target” rate of the speech-based attribute within the multi-speaker audio recording is computed. This discrepancy is used to generate and sample from a distribution of amounts of the speech-based attribute to determine the amount of the speech-based attribute to be included in one or more subsequent generated portions of the same multi-speaker audio recording.

One technical advantage of the disclosed techniques relative to prior approaches is the ability to generate a diverse and accurately labeled set of data for the purposes of training and/or evaluating a machine learning model on speaker diarization and/or related tasks. Accordingly, the disclosed techniques may be used to overcome issues with privacy, data imbalance, diversity, and labeling overhead associated with collecting real-world speaker diarization data. Another technical advantage of the disclosed techniques is the ability to generate multi-speaker or multi-talker audio data that adheres to specific distributions of speech overlap, silence, and/or other speech-based attributes. Consequently, the disclosed techniques may be used to generate synthetic speech data that mimics real human dialogue more accurately than conventional multi-speaker or multi-talker data simulators. In turn, machine learning models that are trained and/or tested using this synthetic speech data may perform better on speaker diarization, voice activity detection, and/or other tasks than machine learning models that are trained and/or tested using data from conventional multi-speaker or multi-talker data simulators.

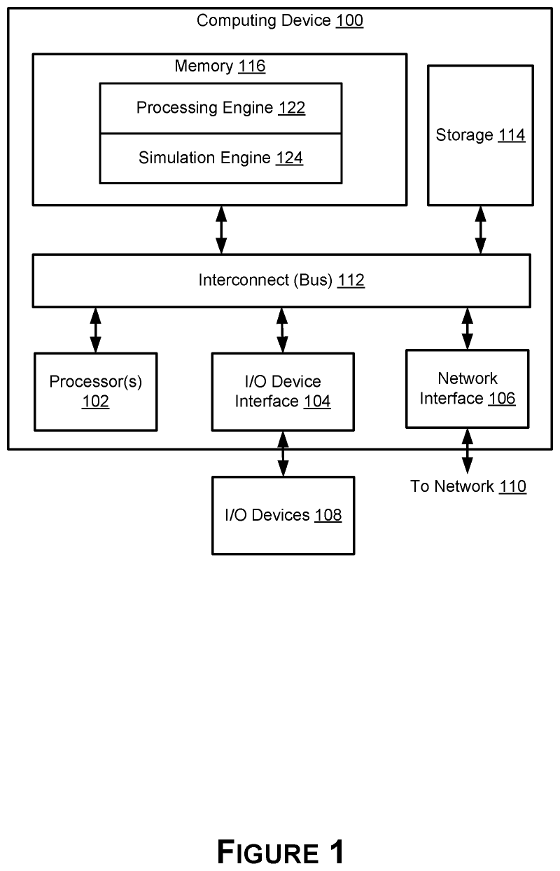

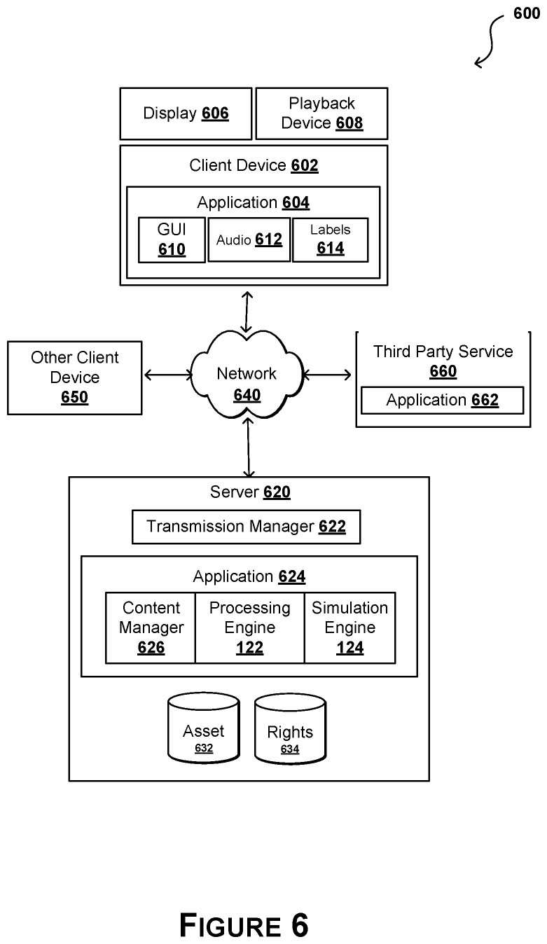

FIG. 1 illustrates a computing device configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system on a chip, a computing system of an autonomous, semi-autonomous, or a non-autonomous machine, a (e.g., talking) kiosk, a smart display, and/or any other type of computing device configured to receive input, process data, and optionally display images, and is suitable for practicing one or more embodiments. Computing device 100 is configured to run a processing engine 122 and a simulation engine 124 that may reside in a memory 116. It is noted that the computing device described herein is illustrative and that any other technically feasible configurations fall within the scope of the present disclosure. For example, multiple instances of processing engine 122 and/or simulation engine 124 may execute on a set of nodes in a distributed and/or cloud computing system to implement the functionality of computing device 100. Alternatively or additionally, computing device 100 may be implemented in a similar manner to the devices and/or systems described at least with respect to FIGS. 6-14.

In one or more embodiments, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center or a machine) and/or may correspond to a virtual computing instance executing within a computing cloud.

In at least one embodiment, I/O devices 108 include devices capable of receiving input, such as a keyboard, a mouse, a touchpad, a VR/MR/AR headset, a gesture recognition system, a steering wheel, mechanical, digital, or touch sensitive buttons or input components, and/or a microphone, as well as devices capable of providing output, such as a display device, haptic device, and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In at least one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, an ad hoc network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Processing engine 122 and/or simulation engine 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs or more generally software code that may be executed by processor(s) 102 and application data associated with said software programs, including processing engine 122 and/or simulation engine 124.

Processing engine 122 and simulation engine 124 include functionality to perform probabilistic generation of speaker diarization data, in which probabilistic models are used to control the generation of synthetic speech data that includes (i) multi-speaker audio recordings and (ii) labels that specify speaker identities and start and end timestamps for individual utterances within the multi-speaker audio recordings. The probabilistic models are used in conjunction with parameters that characterize the occurrences of various speech-based attributes within the synthetic speech data. For example, these parameters may be used to determine a distribution of overlapping speech, a distribution of silence, and/or other distributions of speech-based attributes in the multi-speaker audio recordings.

As described in further detail herein, these processing engine 122 and simulation engine 124 use these parameters to generate synthetic multi-speaker recordings that capture properties of real human dialogue. These synthetic multi-speaker recordings may then be used to train and/or evaluate machine learning models on speaker diarization, voice activity detection, and/or other tasks, thereby improving the performance of the machine learning models and/or the ability to evaluate the performance of the machine learning models.

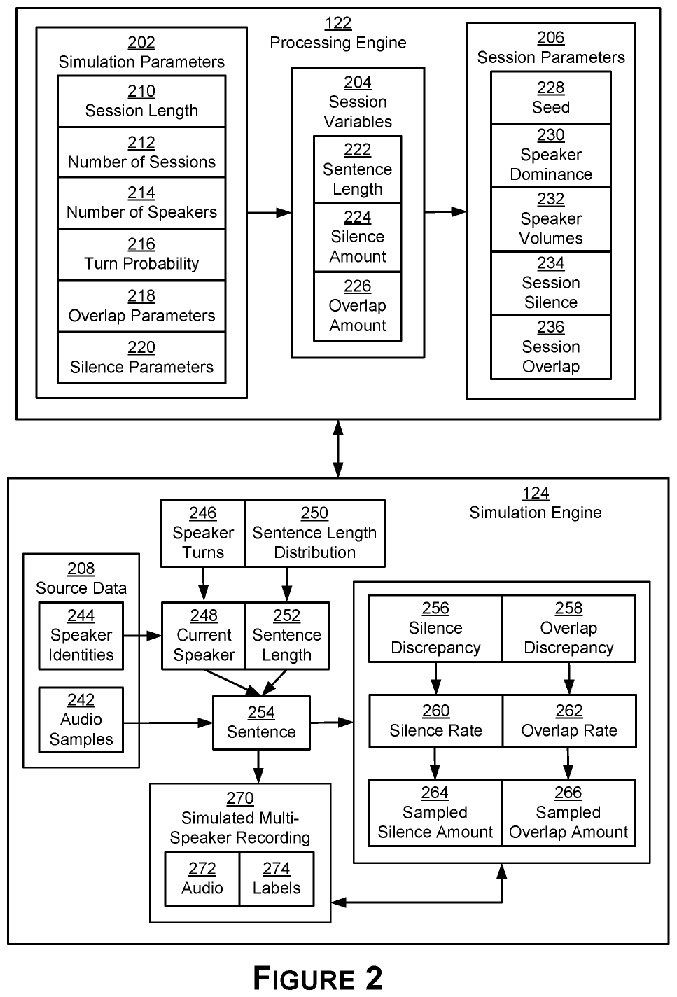

FIG. 2 illustrates a system for generating speaker diarization data that includes processing engine 122 and simulation engine 124 of FIG. 1, according to various embodiments. As shown in FIG. 2, processing engine 122 determines a set of simulation parameters 202, a set of session variables 204, and a set of session parameters 206 used to generate the speaker diarization data.

In some embodiments, simulation parameters 202 include user-specified parameters for controlling the generation of a simulated multi-speaker recording 270. Simulation parameters 202 include (but are not limited to) a session length 210, a number of sessions 212, a number of speakers 214, a turn probability 216, one or more overlap parameters 218, and/or one or more silence parameters 220.

Session length 210 represents the total duration of each “session” of speech (e.g., a period of audio representing a dialogue or conversation) within simulated multi-speaker recording 270. For example, session length 210 may be denoted by L_{S} and include a floating point number that specifies the total number of seconds spanned by each session in simulated multi-speaker recording 270. Session length 210 may also, or instead, include a list of multiple floating point numbers L_{S}={l₁, l₂, . . . , l_{N}_{_{S}}} indexed from 1 to a total number of sessions 212 N_{S}. Each element in the list represents the period of time spanned by a corresponding session within simulated multi-speaker recording 270.

Number of sessions 212 represents the number of sessions to simulate within a given simulated multi-speaker recording 270. Continuing with the above example, number of sessions 212 may be denoted by N_{S} and include a non-negative integer. Number of sessions 212 may additionally be multiplied by session length 210 to obtain a total duration of simulated multi-speaker recording 270 as L_{S}×N_{S} seconds (when session length 210 is the same for all sessions) or as Σᵢ₌₁^{N}^{_{S}}lᵢ (when session length 210 is specified for individual sessions).

Number of speakers 214 indicates the number of speakers within a given session. For example, number of speakers 214 may be denoted by Nₛₚₖ and include a non-negative integer that specifies the number of speakers participating within each session of simulated multi-speaker recording 270. Number of speakers 214 may also, or instead, include a list of non-negative integers Nₛₚₖ={n₁, n₂, . . . , n_{N}_{_{S}}} indexed from 1 to the total number of sessions 212 N_{S}. Each element in the list represents the number of speakers for a corresponding session within simulated multi-speaker recording 270.

Turn probability 216 controls the rate with which speakers take turns speaking within a given session and/or simulated multi-speaker recording 270. For example, turn probability 216 may be denoted by pₜᵤᵣₙ and include a floating point number that specifies the probability with which a new speaker is chosen during the generation of simulated multi-speaker recording 270 and/or a given session within simulated multi-speaker recording 270.

Overlap parameters 218 specify the amount of overlap in speech (e.g., periods where multiple speakers are talking at the same time) within simulated multi-speaker recording 270. For example, overlap parameters 218 may include a mean of μₒ and a variance σₒ² for a distribution of the proportion of overlap in speech within simulated multi-speaker recording 270.

Silence parameters 220 specify the amount of silence (e.g., periods where no one is speaking) within simulated multi-speaker recording 270. For example, silence parameters 220 may include a mean of μₛ and a variance σ₂² for a distribution of the proportion of silence within simulated multi-speaker recording 270.

In some embodiments, session variables 204 represent random variables that are created for individual sessions within simulated multi-speaker recording 270. These random variables include, as examples, a sentence length 222, a silence amount 224, and/or an overlap amount 226.

Sentence length 222 specifies the number of words in a given sentence within simulated multi-speaker recording 270. For example, sentence length 222 may be denoted by sₗ and include a non-negative integer representing the number of words to be included in a newly added utterance (which is also referred to herein as a sentence 254).

Silence amount 224 represents the amount of silence between consecutive sentences within a given session. For example, silence amount 224 may include a non-negative floating point number that represents the amount of time between consecutive sentences in the session.

Overlap amount 226 represents the amount of overlap in speech between consecutive sentences within a given session. For example, overlap amount 226 may include a non-negative floating point number that represents the amount of time in which the end of a given sentence overlaps with the beginning of the next sentence in the session.

Session parameters 206 include attributes that are sampled at the beginning of each session to control the generation of speech and/or other audio within that session. Session parameters 206 include a seed 228, a speaker dominance 230, a set of speaker volumes 232, a session silence 234, and a session overlap 236.

Seed 228 is an attribute that is used to create a reproducible session environment. For example, seed 228 may be set to a random integer and/or another numeric value that represents simulation parameters 202, session variables 204, and/or session parameters 206 for a given session. After seed 228 is determined, seed 228 may be stored with the corresponding simulation parameters 202, session variables 204, and/or session parameters 206 as a representation of and/or index to the corresponding simulation parameters 202, session variables 204, and/or session parameters 206.

Speaker dominance 230 represents the dominance of each speaker within the session. For example, speaker dominance 230 may be set to one or more integers, floating point numbers, and/or other numeric values. Each numeric value may represent the relative amount of time with which a corresponding speaker engages in speech within the session.

Speaker volumes 232 represent the volumes of speakers within the session. For example, speaker volumes 232 may be set to one or more integers, floating point numbers, and/or other numeric values. Each numeric value may represent the relative volume of a corresponding speaker within the session and/or a distribution of volumes for the corresponding speaker within the session.

Session silence 234 represents the amount of silence within the session, and session overlap 236 represents the amount of overlap within the session. In one or more embodiments, mean values for session silence 234 and session overlap 236 are determined using a method of moments estimation technique for a Beta distribution:

$${α}_{\{ o , s \}} = \frac{{μ}_{\{ o , s \}}^{2} \cdot ( 1 - {μ}_{\{ o , s \}} )}{{σ}_{\{ o , s \}}^{2}} - {μ}_{\{ o , s \}} \qquad ( 1 )$$

$${β}_{\{ o , s \}} = \frac{{μ}_{\{ o , s \}} \cdot {( 1 - {μ}_{\{ o , s \}} )}^{2}}{{σ}_{\{ o , s \}}^{2}} - ( 1 - {μ}_{\{ o , s \}} ) \qquad ( 2 )$$

In the above equations, μ and σ represent the mean and variance of the proportion of silence s or overlap o within the session, respectively. Values of μ and σ may be user-specified to control the overall amount of silence and overlap in the session. To ensure that α_{{o,s}}>0 and β_{{o,s}}>0, the inputted values of μ and σ may be constrained to fall within the following ranges:

$$\{ \begin{matrix}0 < {μ}_{\{ o , s \}} < 1 \\ 0 < {σ}_{\{ o , s \}}^{2} \leq {μ}_{\{ o , s \}} ( 1 - {μ}_{\{ o , s \}} )\end{matrix} \qquad ( 3 )$$

A session silence mean X_{μ}_{ₛ} and a session overlap mean X_{μ}_{ₒ} may then be sampled from respective Beta distributions as follows:

$${X}_{{μ}_{s}} ∼ Beta ( {α}_{s} , {β}_{s} ) \qquad ( 4 )$$

$${X}_{{μ}_{o}} ∼ Beta ( {α}_{o} , {β}_{o} ) \qquad ( 5 )$$

In the above equations, αₛ and βₛ are computed by inputting the mean μₛ and variance σₛ from silence parameters 220 into Equations 1 and 2, and αₒ and βₒ are computed by inputting the mean μₒ and variance σₒ from overlap parameters 218 into Equations 1 and 2. In other embodiments, the session silence mean and/or session overlap mean can be sampled from other types of distributions.

After simulation parameters 202, session variables 204, and session parameters 206 have been defined and/or initialized by processing engine 122, simulation engine 124 uses simulation parameters 202, session variables 204, and session parameters 206 to generate simulated multi-speaker recording 270. In the following description of the operation of simulation engine 124, nₛ denotes a current sample count, sₛₚₖ denotes a speaker index, and \tilde{L}ₛ represents a current running length of a portion of simulated multi-speaker recording 270 that has already been generated by simulation engine 124.

As shown in FIG. 2, simulation engine 124 generates simulated multi-speaker recording 270 from source data 208 that includes speaker identities 244 and audio samples 242. Speaker identities 244 include unique identifiers for different speakers in source data 208. For example, speaker identities 244 may include numeric and/or other types of unique identifiers for the speakers. Audio samples 242 include samples of speech from speakers represented by speaker identities 244. Within source data 208, each audio sample may be associated with (e.g., mapped to) a corresponding speaker identity to allow simulation engine 124 to identify speakers for different audio samples 242. Each audio sample may also, or instead, be annotated with start and end timestamps of individual speaker utterances and the corresponding speaker identities 244.

In one or more embodiments, simulation engine 124 continuously monitors the current running length \tilde{L}ₛ of a given session within simulated multi-speaker recording 270. While the current running length is less than a corresponding session length 210 (e.g., \tilde{L}ₛ<L_{S}), simulation engine 124 continues generating audio 272 and corresponding labels 274 for inclusion in the session.

In some embodiments, simulation engine 124 determines speaker turns 246 representing instances in which different speakers speak within the session by comparing turn probability 216 pₜᵤᵣₙ with a value drawn from a uniform distribution:

$$U ( 0 , 1 ) < {p}_{turn} \qquad ( 6 )$$

If the sampled value is less than turn probability 216, a randomly chosen speaker is selected from a pre-determined group of speakers with corresponding speaker identities 244, as represented by Sₛₚₖₛ={s₁, s₂, . . . , s_{N}_{ₛₚₖ}}. The randomly chosen speaker corresponds to a current speaker 248 for the portion of the session to be generated.

Next, simulation engine uses a sentence length distribution 250 to determine a sentence length 252 for a sentence to be spoken by current speaker 248. In some embodiments, sentence length 252 is denoted by sₗ and is sampled from a negative binomial distribution corresponding to sentence length distribution 250:

$${s}_{l} ∼ NB ( {k}_{w} , {p}_{w} ) \qquad ( 7 )$$

The probability mass function of the negative binomial distribution includes the following representation:

$${P}_{NB} ( X = {k}_{w} ) = ( \begin{matrix}X + {k}_{w} - 1 \\ {k}_{w} - 1\end{matrix} ) {{p}_{w}^{{k}_{w}} ( 1 - {p}_{w} )}^{x} \qquad ( 8 )$$

In Equations 7 and 8, k_{w} and p_{w} are parameters that may be specified by a user to control for properties of sentence length distribution 250.

After sentence length 252 and current speaker 248 are determined, simulation engine 124 adds a corresponding sentence 254 to audio 272 by selecting the corresponding number of words from one or more audio samples 242 associated with current speaker 248. For example, simulation engine 124 may generate sentence 254 as a sequence of randomly selected words from audio samples 242 spoken by current speaker 248. Simulation engine 124 may also, or instead, generate sentence 254 by extracting and/or combining one or more utterances and/or portions of one or more utterances of current speaker 248 from one or more corresponding audio samples 242.

The operation of simulation engine 124 in generating sentence 254 may be represented by the following:

$${\tilde{L}}_{spch} , {\tilde{L}}_{sil} = BuildSentence ( {s}_{l} , {s}_{spk} ) \qquad ( 9 )$$

In the above equation, \tilde{L}_{spch} represents the duration of speech within currently generated audio 272 for the session, and \tilde{L}ₛᵢₗ represents the duration of silence within currently generated audio 272 for the session. The “BuildSentence” call may thus be used to generate a given sentence 254 with a certain sentence length 252 sₗ and current speaker 248 sₛₚₖ, add the generated sentence 254 to audio 272 for the session, and compute updated values for the duration of speech and duration of silence within audio 272 for the session based on the newly added sentence 254.

After sentence 254 is generated, simulation engine 124 determines a silence discrepancy 256 and an overlap discrepancy 258 associated with currently generated audio 272 for the session. In one or more embodiments, silence discrepancy 256 represents the discrepancy between the amount of silence in audio 272 for the session and a “target” amount of silence for the session. Similarly, overlap discrepancy 258 represents the discrepancy between the amount of overlap in speech within audio 272 for the session and the “target” amount of overlap in speech for the session.

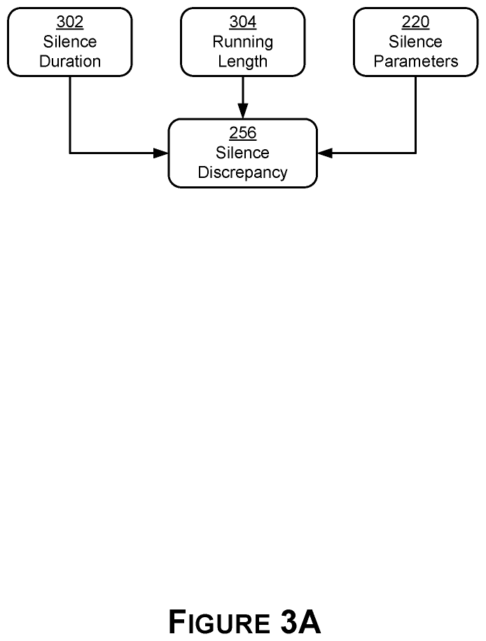

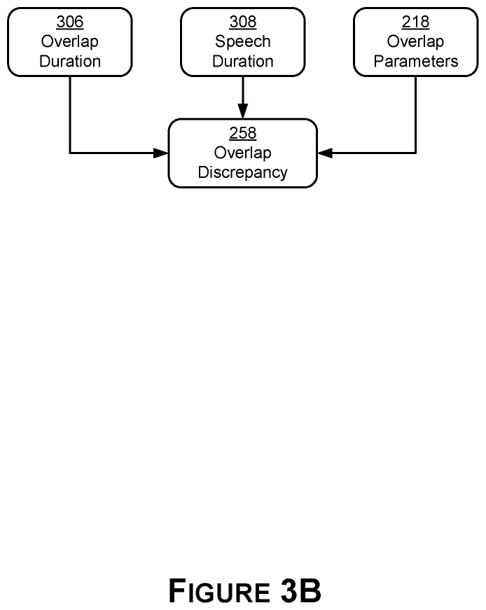

FIG. 3A illustrates the calculation of silence discrepancy 256 for a generated portion of a session within simulated multi-speaker recording 270, according to various embodiments. As shown in FIG. 3A, silence discrepancy 256 is computed using a silence duration 302 for the generated portion (e.g., the amount of time spanned by silence within the generated portion of the session), a running length 304 of the generated portion (e.g., the total amount of time spanned by the generated portion of the session), and one or more silence parameters 220.

For example, silence discrepancy 256 may be calculated using the following equation:

$$Δ S = \frac{{\tilde{L}}_{sil}}{{\tilde{L}}_{S}} - {μ}_{s} \qquad ( 10 )$$

In the above equation, silence discrepancy 256 is represented by ΔS and is computed as the difference between the ratio of silence duration 302 \tilde{L}ₛᵢₗ to running length 304 \tilde{L}_{S} and the mean us of the distribution of the proportion of silence within simulated multi-speaker recording 270.

FIG. 3B illustrates the calculation of overlap discrepancy 258 for a generated portion of a session within simulated multi-speaker recording 270, according to various embodiments. As shown in FIG. 3B, overlap discrepancy 258 is computed using an overlap duration 306 for the generated portion (e.g., the amount of time spanned by overlapping speech within the generated portion of the session), a speech duration 308 of the generated portion (e.g., the amount of time spanned by speech within the generated portion of the session), and one or more overlap parameters 218.

For example, overlap discrepancy 258 may be calculated using the following equation:

$$Δ O = \frac{{\tilde{O}}_{spch}}{{\tilde{L}}_{spch}} - {μ}_{o} \qquad ( 11 )$$

In the above equation, overlap discrepancy 258 is represented by ΔO and is computed as the difference between the ratio of overlap duration 306 Õ_{spch} to speech duration 308 \tilde{L}_{spch}, and the mean μₒ of the distribution of the proportion of overlap within simulated multi-speaker recording 270.

Returning to the discussion of FIG. 2, after silence discrepancy 256 and overlap discrepancy 258 are determined, simulation engine 124 uses silence discrepancy 256 and overlap discrepancy 258 to determine a silence rate 260 representing the amount of silence to be added to the session and/or an overlap rate 262 representing the amount of overlap in speech to be added to the session. In some embodiments, simulation engine 124 determines the larger of silence discrepancy 256 and overlap discrepancy 258. If silence discrepancy 256 is larger, simulation engine 124 determines a corresponding silence rate 260 representing the amount of silence to be added to the session to account for silence discrepancy 256. If overlap discrepancy 258 is larger, simulation engine 124 determines a corresponding overlap rate 262 representing the amount of overlap in speech to be added to the session to account for overlap discrepancy 258.

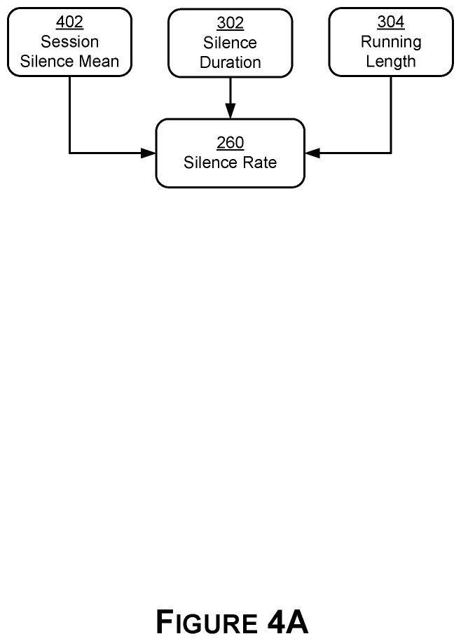

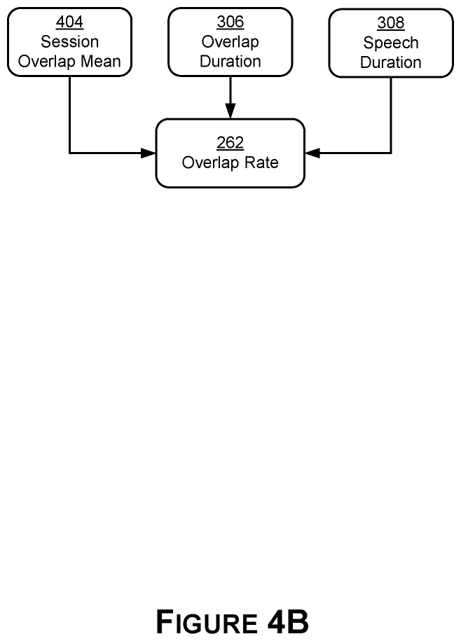

FIG. 4A illustrates the calculation of silence rate 260 for a generated portion of a session within simulated multi-speaker recording 270, according to various embodiments. As shown in FIG. 4A, silence rate 260 is computed using a session silence mean 402 for the session, silence duration 302, and running length 304.

For example, silence rate 260 may be denoted as \tilde{m}ₛ and be included in an equation that models the difference between the current proportion of silence within the generated portion of the session and a corresponding session silence mean 402 (as denoted by X_{μ}_{ₛ}):

$${X}_{{μ}_{s}} = \frac{{\tilde{m}}_{s} + {\tilde{L}}_{sil}}{{\tilde{m}}_{s} + {\tilde{L}}_{s}} \qquad ( 12 )$$

Silence rate 260 may thus be determined by rewriting Equation 12 to assign a value to \tilde{m}ₛ:

$${\tilde{m}}_{s} ← \frac{{\tilde{L}}_{sil} - {X}_{{μ}_{s}} {\tilde{L}}_{s}}{{X}_{{μ}_{s}} - 1} \qquad ( 13 )$$

Consequently, silence rate 260 may be computed as the difference between silence duration 302 \tilde{L}ₛᵢₗ and the product of session silence mean 402 X_{μ}_{ₛ} and running length 304 \tilde{\tilde{L}}ₛ, divided by the difference between session silence mean 402 X_{μ}_{ₛ} and 1.

FIG. 4B illustrates the calculation of overlap rate 262 for a generated portion of a session within simulated multi-speaker recording 270, according to various embodiments. As shown in FIG. 4B, overlap rate 262 is computed using a session overlap mean 404 for the session, overlap duration 306, and speech duration 308.

For example, overlap rate 262 may be denoted as \tilde{m}ₒ and be included in an equation that models the difference between the current proportion of overlap in speech within the generated portion of the session and a corresponding session overlap mean 404 (as denoted by X_{μ}_{ₒ}):

$${X}_{{μ}_{o}} = \frac{{\tilde{m}}_{o} + {\tilde{O}}_{spch}}{{\tilde{L}}_{spch} - {\tilde{m}}_{o}} \qquad ( 14 )$$

Overlap rate 262 may thus be determined by rewriting Equation 14 to assign a value to \tilde{m}ₒ:

$${\tilde{m}}_{o} ← \frac{{X}_{{μ}_{o}} {\tilde{L}}_{sp ch} - {\tilde{O}}_{spch}}{{X}_{{μ}_{o}} + 1} \qquad ( 15 )$$

Consequently, overlap rate 262 may be computed as the difference between session overlap mean 404 X_{μ}_{ₒ} multiplied by speech duration \tilde{L}_{spch} and overlap duration 306 Õ_{spch}, divided by the sum of session overlap mean 404 X_{μ}_{ₒ} and 1.

Returning to the discussion of FIG. 2, after computing silence rate 260 or overlap rate 262 for a given session within simulated multi-speaker recording 270, simulation engine 124 samples from one or more distributions associated with silence rate 260 or overlap rate 262 to determine a corresponding sampled silence amount 264 or sampled overlap amount 266. In some embodiments, sampled silence amount 264 and sampled overlap amount 266 represent values of session variables 204 for silence amount 244 or overlap amount 226, respectively, to be added to a session of simulated multi-speaker recording 270 after a corresponding sentence 254 has been added to the session.

In one or more embodiments, simulation engine 124 uses the following equations to determine sampled silence amount 264 or sampled overlap amount 266:

$$k ← {\tilde{m}}^{2} / {σ}^{2} \qquad ( 16 )$$

$$θ ← {σ}^{2} / \tilde{m} \qquad ( 17 )$$

$${x}_{Δ t} - Γ ( k , θ ) \qquad ( 18 )$$

In the above equations, simulation engine 124 computes a parameter k as the square of silence rate 260 or overlap rate 262 (as represented by \tilde{m}²) divided by the standard deviation for the corresponding amount of silence or overlap within the session (e.g., as specified by a user). Simulation engine 124 also computes a parameter θ as the standard deviation for the amount of silence of overlap within the session divided by the corresponding silence rate 260 or overlap rate 262. Simulation engine 124 uses k and θ to parameterize a gamma distribution, which is the continuous version of the negative binomial sentence length distribution 250. Simulation engine 124 additionally samples x_{Δt} as a sampled silence amount 264 s_{Δt} or as a sampled overlap amount 266 o_{Δt} for the corresponding sentence 254.

Finally, simulation engine 124 adds, to audio 272 included in the session, silence according to sampled silence amount 264 or overlap in speech according to sampled overlap amount 266. For example, simulation engine 124 may add sampled silence amount 264 as audio 272 that lacks sound or speech at the end of sentence 254. In another example, simulation engine 124 may add sampled overlap amount 266 by determining a new current speaker 248 using speaker turns 246 and turn probability 216, sampling from sentence length distribution 250 to determine another sentence length 252 for the new current speaker 248, and adding a new sentence 254 formed from audio samples 242 for the new current speaker to audio 272 so that the new sentence 254 overlaps with the previous sentence 254 by sampled overlap amount 266. In this example, when the same current speaker 248 as the previous sentence is reselected using speaker turns 246 and turn probability 216, simulation engine 124 may omit adding overlapping speech to audio 272 that includes the previous sentence 254 (e.g., because a speaker should be incapable of overlapping himself or herself in speech). Simulation engine 124 may also, or instead, continue using speaker turns 246 and turn probability 216 to select one or more additional current speakers until a selected current speaker 248 is different from current speaker 248 for the previous sentence 254. Simulation engine 124 may also, or instead, omit current speaker 248 for the previous sentence 254 from the group of speakers from which a new current speaker 248 for the overlapping sentence 254 is selected to ensure that overlapping sentences in audio 272 are associated with different speakers.

Simulation engine 124 additionally generates corresponding labels 274 associated with the overlapping and/or non-overlapping speech within the newly added audio 272. For example, simulation engine 124 may add labels 274 that include start times, end times, and speakers associated with individual sentences (or utterances) within audio 272. Simulation engine 124 then repeats the process with additional speakers and sentences until the running length of audio 272 in the session reaches session length 210. Simulation engine 124 may also generate additional sessions within simulated multi-speaker recording 270 until number of sessions 212 is reached.

The operation of simulation engine 124 in generating a session of audio 272 within simulated multi-speaker recording 270 may be represented by the following example sequence of operations:

```
Require: L_{S}, μₒ, μₛ, pₜᵤᵣₙ, σₒ², σₛ² ∈ [symbol]  , Nₛₚₖ ∈ [symbol]
  p ∈ (0,1] ∨ μₒ, μₛ, σₒ², σₛ² ∈ [0,1]
  ${α}_{s} , {β}_{s} ← ( \frac{{μ}_{s}^{2} \cdot ( 1 - {μ}_{s} )}{{σ}_{s}^{2}} - {μ}_{s} , \frac{{{μ}_{s} ( 1 - {μ}_{s} )}^{2}}{{σ}_{s}^{2}} - ( 1 - {μ}_{s} ) )$
  X_{μ}_{ₛ} ~ Beta(αₛ, βₛ)
  ${α}_{o} , {β}_{o} ← ( \frac{{μ}_{o}^{2} \cdot ( 1 - {μ}_{o} )}{{σ}_{o}^{2}} - {μ}_{o} , \frac{{{μ}_{o} ( 1 - {μ}_{o} )}^{2}}{{σ}_{o}^{2}} - ( 1 - {μ}_{o} ) )$
  X_{μ}_{ₒ} ~ Beta(αₒ, βₒ)
  while \tilde{L}ₛ < L_{S} do
    if U(0,1) < pₜᵤᵣₙ then
      sₛₚₖ = GetNextSpeaker(Sₛₚₖₛ, sₛₚₖ)
  endif
  sₗ ~NB(k_{w}, p_{w})
  \tilde{L}_{spch}, \tilde{L}ₛᵢₗ = BuildSentence(sₗ, sₛₚₖ)
  $Δ S ← \frac{{\tilde{L}}_{sil}}{{\tilde{L}}_{S}} - {μ}_{s}$
  $Δ O ← \frac{{\tilde{O}}_{spch}}{{\tilde{L}}_{spch}} - {μ}_{o}$
  if ΔS ≤ ΔO then
    ${\tilde{m}}_{s} = \frac{{\tilde{L}}_{sil} - {X}_{{μ}_{s}} {\tilde{L}}_{s}}{{X}_{{μ}_{s}} - 1}$
    kₛ ← \tilde{m}ₛ²/σₛ²
    θₛ ← σₛ²/\tilde{m}ₛ²
    s_{Δt}~Γ(kₛ, θₛ)
    AddSentence(s_{Δt}, 0)
  else if ΔS > ΔO then
    ${\tilde{m}}_{o} = \frac{{X}_{{μ}_{o}} {\tilde{L}}_{spch} - {\tilde{O}}_{spch}}{{X}_{{μ}_{o}} + 1}$
    kₒ ← \tilde{m}ₒ²/σₒ²
    θₒ ← σₒ²/\tilde{m}ₒ²
    o_{Δt}~Γ(kₒ, θₒ)
    AddSentence(0, o_{Δt})
  end if
end while
```

In the above sequence of operations, simulation engine 124 initializes variables L_{S}, μₒ, μₛ, pₜᵤᵣₙ, σₒ², σₛ², Nₛₚₖ. Simulation engine 124 also initializes parameters of Beta distributions associated with session silence 234 and session overlap 236 and samples a session silence 234 mean X_{μ}_{ₛ} and a session overlap 236 mean X_{μ}_{ₒ} from the Beta distributions.

Next, simulation engine 124 executes a while loop that adds individual sentences of audio 272 to the session. During each iteration of the while loop, simulation engine 124 selects current speaker 248 based on turn probability 216 pₜᵤᵣₙ, the group of speakers for the session Sₛₚₖₛ, and the previously selected current speaker 248 sₛₚₖ. Simulation engine 124 also samples sentence length 252 sₗ from a negative binomial sentence length distribution 250 NB(k_{w},p_{w}) and generates a corresponding sentence 254 using the “BuildSentence” function. Simulation engine 124 then computes silence discrepancy 256 and overlap discrepancy 258 using updated values of speech duration and silence duration returned by the “BuildSentence” function.

If silence discrepancy 256 is less than or equal to overlap discrepancy 258, simulation engine 124 computes silence rate 260 \tilde{m}ₛ, computes parameters kₛ and θₛ of a gamma distribution based on silence rate 260, and samples from the gamma distribution to determine sampled silence amount 264 s_{Δt}. Simulation engine 124 then calls an “AddSentence” function to add the corresponding amount of silence to audio 272 in the session (e.g., at the end of the previously added sentence 254).

If silence discrepancy 256 is greater than overlap discrepancy 258, simulation engine 124 computes overlap rate 262 \tilde{m}ₒ, computes parameters of a gamma distribution kₒ and θₒ based on overlap rate 262, and samples from the gamma distribution to determine sampled overlap amount 266 o_{Δt}. Simulation engine 124 then calls the “AddSentence” function to add an additional sentence to audio 272 in the session so that the additional sentence overlaps with the previously added sentence by sampled overlap amount 266. Simulation engine 124 continues performs additional iterations of the while loop until the running length of audio 272 \tilde{L}ₛ reaches session length 210 L_{S}.

While the operation of processing engine 122 and simulation engine 124 has been described above with respect to generating audio 272 that adheres to rates and/or distributions of silence and overlap in speech, it will be appreciated that processing engine 122 and simulation engine 124 may be used to generate simulated multi-speaker recordings that reflect other types of speech-based attributes. For example, the functionality of processing engine 122 and simulation engine 124 may be used to generate one or more sessions of audio 272 within simulated multi-speaker recording 270 that adhere to distributions of and/or representative values for speaking rates, word lengths, vocabularies, cadences, pitches, volumes, types of speech, and/or other attributes associated with human speech.

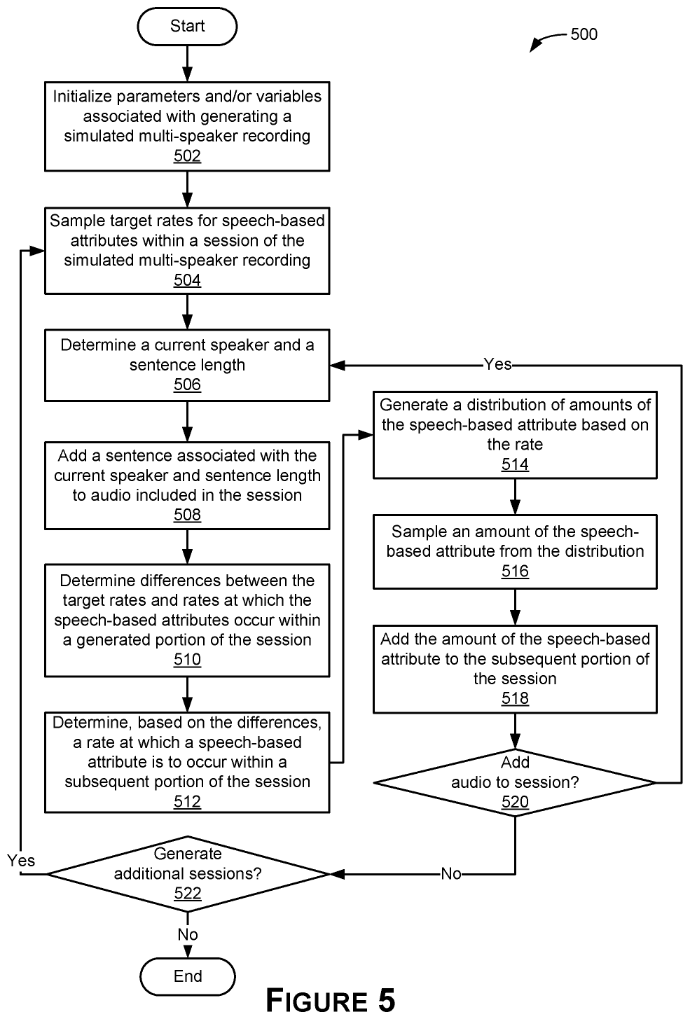

Now referring to FIG. 5, each block of method 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by simulated way of example, with respect to the systems of FIGS. 1-2. However, these methods may additionally or alternatively be executed by any one system, or any combination of systems, including, but not limited to, those described herein. Further, the operations in method 500 may be omitted, repeated, and/or performed in any order without departing from the scope of the present disclosure.

FIG. 5 illustrates a flow diagram of a method 500 for generating a simulated multi-speaker recording, according to various embodiments. As shown in FIG. 5, method 500 begins with operation 502, in which processing engine 122 initializes parameters and/or variables associated with generating a simulated multi-speaker recording. For example, processing engine 122 may receive and/or sample one or more session lengths, a number of sessions, a number of speakers in each session, a turn probability, one or more overlap parameters, one or more silence parameters, and/or one or more other parameters associated with generating the simulated multi-speaker recording. Processing engine 122 may also, or instead, initialize variables representing a sentence length, a silence amount, an overlap amount, and/or other speech-based attributes. Processing engine 122 may also, or instead, generate session-specific parameters such as a random seed, a speaker dominance, and/or one or more speaker volumes for a given session.

In operation 504, processing engine 122 samples target rates for speech-based attributes within a session of the simulated multi-speaker recording. For example, processing engine 122 may generate Beta distributions from silence parameters, overlap parameters, and/or other parameters associated with speech-based attributes of the session. Processing engine 122 may sample from the Beta distributions to determine mean values (or other types of statistics or representative values) for the speech-based attributes.

In operation 506, simulation engine 124 determines a current speaker and a sentence length. For example, simulation engine 124 may sample from a distribution associated with the turn probability to determine whether or not to select a new current speaker. If a new current speaker is to be selected, simulation engine 124 may choose the new current speaker from a group of speakers selected for the session.

In operation 508, simulation engine 124 adds a sentence associated with the current speaker and sentence length to audio included in the session. For example, simulation engine 124 may sample the sentence length from a negative binomial distribution. Simulation engine 124 may then generate the sentence having the sentence length by combining one or more audio samples and/or portions of audio samples spoken by the current speaker. Simulation engine 124 may add the generated sentence to the end of any previously generated audio for the session. Simulation engine 124 may additionally update a duration of speech, a duration of silence, a running length of the session, and/or other values to reflect the addition of the sentence to the generated audio.

In operation 510, simulation engine 124 determines differences between the target rates and rates at which the speech-based attributes occur within a generated portion of the session. For example, simulation engine 124 may compute a silence discrepancy representing the difference between the rate at which silence occurs within the existing audio for the session and a target rate of silence sampled in operation 504 and/or otherwise specified for the session or simulated multi-speaker recording. Simulation engine 124 may also, or instead, compute an overlap discrepancy representing the difference between the rate at which overlap in speech occurs within the existing audio for the session and the target rate of overlap in speech sampled in operation 504 and/or otherwise specified for the session or simulated multi-speaker recording.

In operation 512, simulation engine 124 determines, based on the differences, a rate at which a speech-based attribute is to occur within a subsequent portion of the session. Continuing with the above example, simulation engine 124 may compare the silence discrepancy and overlap discrepancy (or other values derived from the silence discrepancy and overlap discrepancy). Based on this comparison, simulation engine 124 may determine the speech-based attribute associated with the greater discrepancy. Simulation engine 124 may then compute the rate at which the speech-based attribute associated with the greater discrepancy is to occur based on the rate at which the speech-based attribute currently occurs within the generated portion of the session and the target rate for the speech-based attribute.

In operation 514, simulation engine 124 generates a distribution of amounts of the speech-based attribute based on the rate. For example, simulation engine 124 may compute parameters of a gamma distribution based on the rate computed in operation 512.

In operation 516, simulation engine 124 samples an amount of the speech-based attribute from the distribution. Continuing with the above example, simulation engine 124 may sample from the gamma distribution to determine the number of seconds of the speech-based attribute to add to the session.

In operation 518, simulation engine 124 adds the amount of the speech-based attribute to the subsequent portion of the session. For example, simulation engine 124 may add a certain number of seconds of silence or overlap in speech to audio generated for the session.

In operation 520, simulation engine 124 determines whether or not to add audio to the session. For example, simulation engine 124 may compare the running length of the audio generated for the session to the length of the session. If the running length of the audio meets or exceeds the length of the session, simulation engine 124 may determine that audio should not be added to the session. If the running length of the audio is less than the length of the session, simulation engine 124 may determine that audio should be added to the session.

If simulation engine 124 determines that more audio should be added to the session, simulation repeats operations 506, 508, 510, 512, 514, 516, and 518 to add sentences, silence, overlap in speech, and/or other audio adhering to various speech-based attributes to the session. After each iteration of operations 506, 508, 510, 512, 514, 516, and 518, simulation engine 124 performs operation 520 to determine whether to add more audio to the session.

Once simulation engine 124 determines in operation 520 that no more audio should be added to the session, processing engine 122 performs operation 522, in which processing engine 122 determines whether or not to generate additional sessions within the simulated multi-speaker recording. For example, processing engine 122 may determine that additional sessions are to be generated while the number of generated sessions is less than the total number of sessions specified in parameters for the simulated multi-speaker recording. If processing engine 122 determines that additional sessions are to be generated, processing engine 122 repeats operation 504 to resample target rates for the speech-based attributes for use with a new session of the simulated multi-speaker recording. Simulation engine 124 then performs operations 506, 508, 510, 512, 514, 516, 518, and 520 one or more times to generate audio that adheres to the target rates for inclusion in the new session. Processing engine 122 and simulation engine 124 may thus repeat operations 504, 506, 508, 510, 512, 514, 516, 518, 520, and 522 until processing engine 122 determines in operation 522 that all sessions in the simulated multi-speaker recording have been generated.

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. As discussed, aspects of various approaches presented herein may be lightweight enough to execute on a device such as a client device, such as a personal computer or gaming console, in real-time or near real-time. Such processing may be performed on content that is generated on, or received by, that client device or received from an external source, such as streaming sensor data or other content received over at least one network. In some instances, the processing and/or determination of this content may be performed by one of these other devices, systems, or entities, then provided to the client device (or another such recipient) for presentation or another such use.

As an example, FIG. 6 illustrates an example network configuration 600 that may be used to provide, generate, modify, encode, and/or transmit data or other such content. In at least one embodiment, a client device 602 may generate or receive data for a session using components of an application 604 on client device 602 and data stored locally on that client device. In at least one embodiment, a different application 624 executing on a server 620 (e.g., a cloud server or edge server) may initiate a session associated with at least client device 602, as may use a session manager and user data stored in a user database, and may cause content to be determined by a content manager 626. Content manager 626 may work with processing engine 122 to generate one or more sessions of audio and corresponding labels within a simulated multi-speaker recording. At least a portion of the generated content (separate and different from the assets themselves) may be transmitted to client device 602 using an appropriate transmission manager 622 to send by download, streaming, or another such transmission channel. An encoder may be used to encode and/or compress at least some of this data before transmitting to client device 602. A decoder may also be used to decode data received over the network(s) 640 for presentation via client device 602, such images, text, or video content through a display 606 and audio through at least one audio playback device 608 (e.g., speakers or headphones).

In at least one embodiment, client device 602 receiving such content may provide this content to application 604. Client device 602 may also, or instead, transmit audio 612 (e.g., speech recorded using a microphone on client device 602) and labels 614 (e.g., identities of one or more speakers of the recorded speech) collected and/or managed by application 604 to server 620 for use in generating the simulated multi-speaker recording. A graphical user interface 610 provided by application 604 may be used to control the transmission of data between client device 602 and server 602 and/or the generation of the simulated multi-speaker recording on server 620.

In at least one embodiment, a transmission mechanism such as data streaming may be used to transfer content and/or data between server 620 to client device 602. In at least one embodiment, at least a portion of this content and/or data may be obtained or streamed from another source, such as a third-party service 660 or other client device 650, that may also include an application 662 for generating or providing content. In at least one embodiment, portions of this functionality may be performed using multiple computing devices, or multiple processors within one or more computing devices, such as may include a combination of CPUs and GPUs.

In this example, these client devices may include any appropriate computing devices, as may include a desktop computer, notebook computer, set-top box, streaming device, gaming console, smartphone, tablet computer, VR/AR/MR headset, VR/AR/MR goggles, wearable computer, or a smart television. Each client device may submit a request across at least one wired or wireless network, as may include the Internet, an Ethernet, a local area network (LAN), or a cellular network, among other such options. In this example, these requests may be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency may be reduced by enabling the client devices to interact with servers that are in closer proximity, while also improving security of resources in the cloud provider environment.

In at least one embodiment, such a system may be used for performing graphical rendering and/or audio synthesis operations. In other embodiments, such a system may be used for other purposes, such as for providing image or video content to test or validate autonomous machine applications, or for performing deep learning operations. In at least one embodiment, such a system may be implemented using an edge device, or may incorporate one or more Virtual Machines (VMs). In at least one embodiment, such a system may be implemented at least partially in a data center or at least partially using cloud computing resources.

### Inference and Training Logic

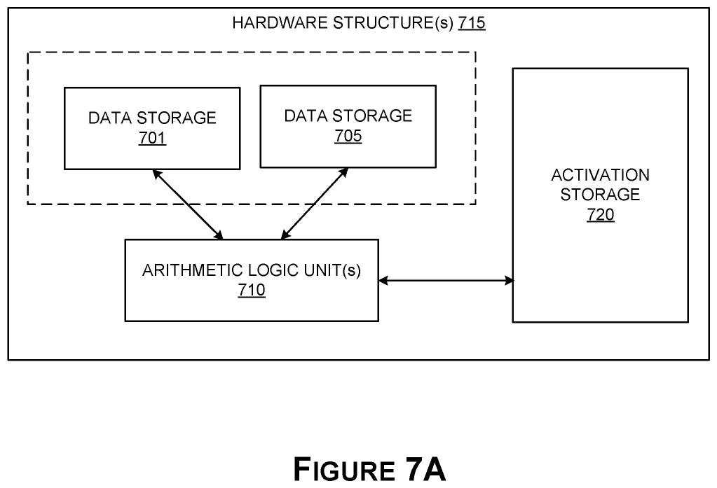

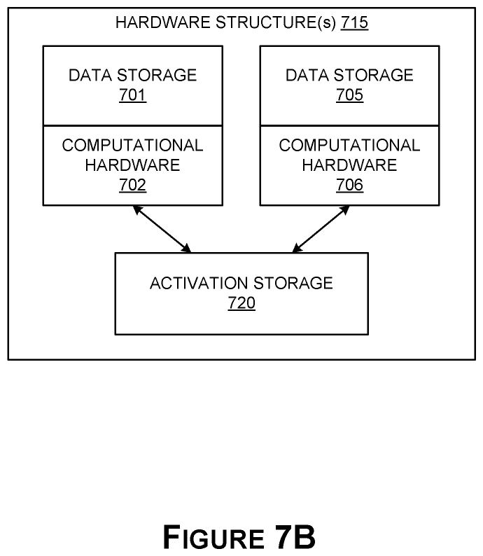

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

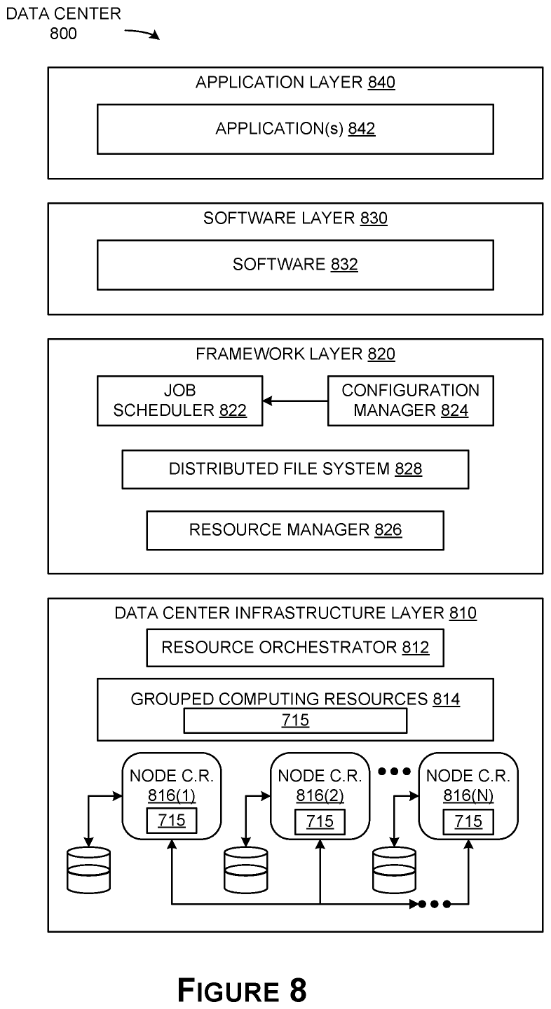

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may be used by at least portions of node C.R.s 816(1)-816(N), grouped computing resources 814, and/or distributed file system 828 of framework layer 820. The one or more types of software 832 may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center 800 may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

In at least one embodiment, inference and/or training logic 715 may be used in system FIG. 8 for inferencing or predicting operations based, at least in part, on weight parameters calculated using neural network training operations, neural network functions and/or architectures, or neural network use cases described herein. Such components may be trained and/or executed using synthetic multi-speaker recordings, which are generated using techniques discussed herein.

### Computer Systems

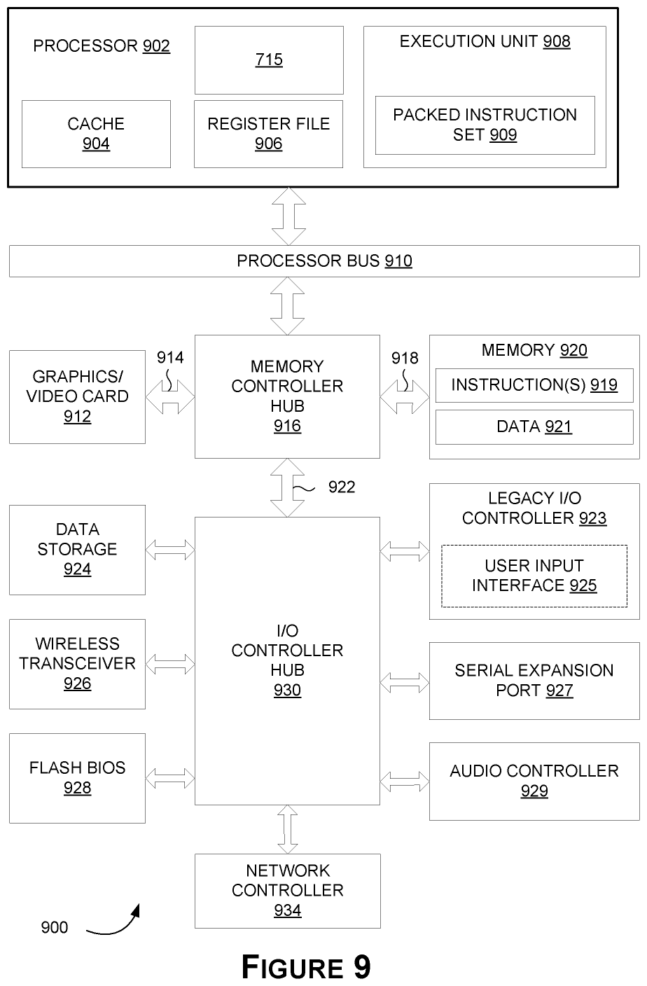

FIG. 9 is a block diagram illustrating an exemplary computer system, which may be a system with interconnected devices and components, a system-on-a-chip (SOC) or some combination thereof 900 formed with a processor that may include execution units to execute an instruction, according to various embodiments. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

In at least one embodiment, inference and/or training logic 715 may be used in system FIG. 9 for inferencing or predicting operations based, at least in part, on weight parameters calculated using neural network training operations, neural network functions and/or architectures, or neural network use cases described herein. Such components may be trained and/or executed using synthetic multi-speaker recordings, which are generated using techniques discussed herein.

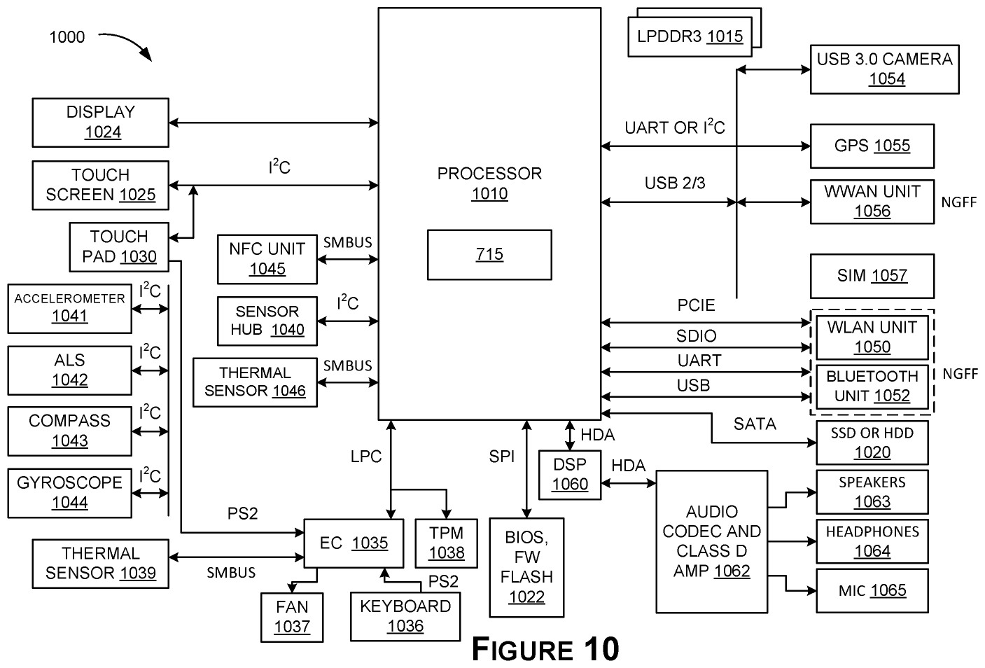

FIG. 10 is a block diagram illustrating an electronic device 1000 for utilizing a processor 1010, according to various embodiments. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

In at least one embodiment, inference and/or training logic 715 may be used in system FIG. 10 for inferencing or predicting operations based, at least in part, on weight parameters calculated using neural network training operations, neural network functions and/or architectures, or neural network use cases described herein. Such components may be trained and/or executed using synthetic multi-speaker recordings, which are generated using techniques discussed herein.

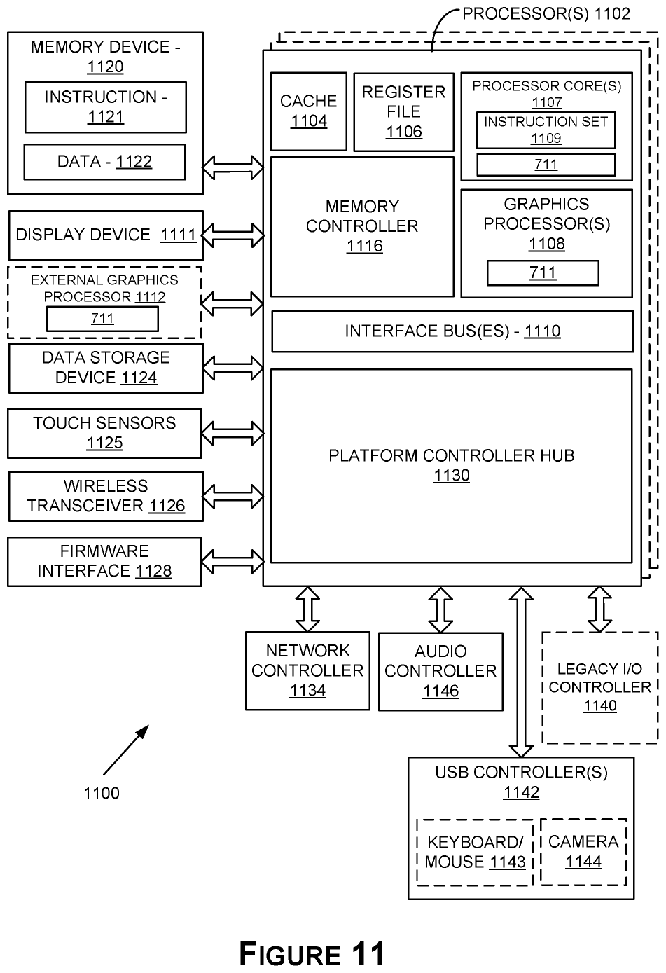

FIG. 11 is a block diagram of a processing system, according to various embodiments. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, or embedded devices.

In at least one embodiment, system 1100 may include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 may also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 may have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, may be a processor bus, such as a version of a Direct Media Interface (DMI) bus. In at least one embodiment, interface bus 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 may be a dynamic random access memory (DRAM) device, a static random access memory (SRAM) device, flash memory device, phase-change memory device, or some other memory device having suitable performance to serve as process memory. In at least one embodiment memory device 1120 may operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 may connect to processor(s) 1102. In at least one embodiment display device 1111 may include one or more of an internal display device, as in a mobile electronic device or a laptop device or an external display device attached via a display interface (e.g., DisplayPort, etc.). In at least one embodiment, display device 1111 may include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 may connect via a storage interface (e.g., SATA) or via a peripheral bus, such as a Peripheral Component Interconnect bus (e.g., PCI, PCI Express). In at least one embodiment, touch sensors 1125 may include touch screen sensors, pressure sensors, or fingerprint sensors. In at least one embodiment, wireless transceiver 1126 may be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and may be, for example, a unified extensible firmware interface (UEFI). In at least one embodiment, network controller 1134 may enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 may also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 may include an external memory controller 1116 and platform controller hub 1130, which may be configured as a memory controller hub and peripheral controller hub within a system chipset that is in communication with processor(s) 1102.

In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein. Such components may be trained and/or executed using synthetic multi-speaker recordings, which are generated using techniques discussed herein.

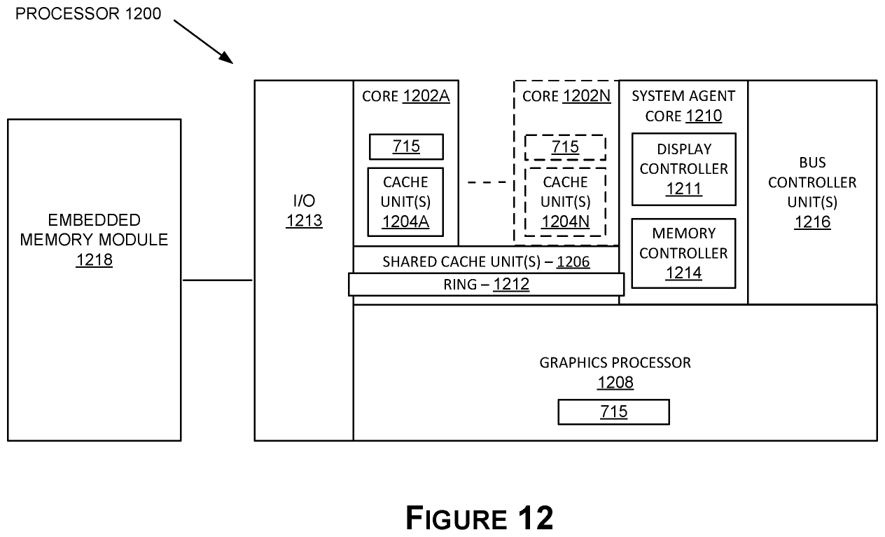

FIG. 12 is a block diagram of a processor 1200 having one or more processor cores 1202A-1202N, an integrated memory controller 1214, and an integrated graphics processor 1208, according to various embodiments. In at least one embodiment, processor 1200 may include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 may be implemented on one or more chips or as an SoC integrated circuit.

In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein. Such components may be trained and/or executed using synthetic multi-speaker recordings, which are generated using techniques discussed herein.

### Virtualized Computing Platform

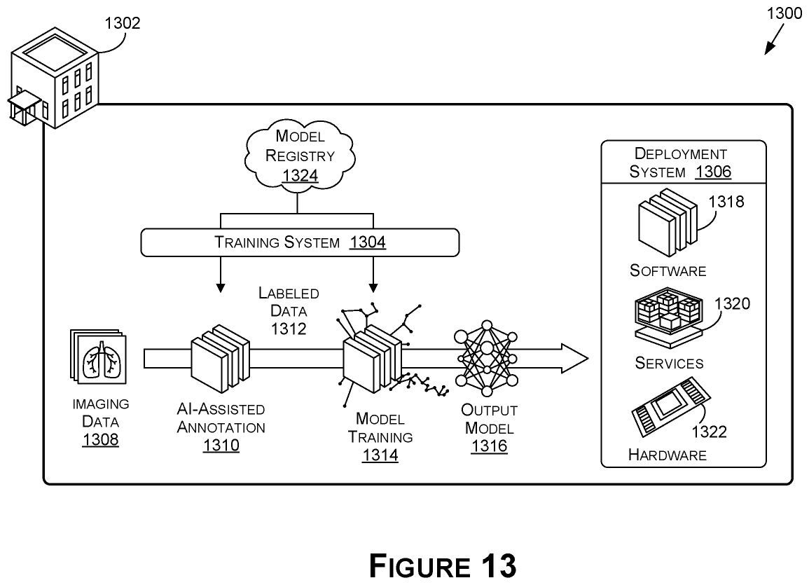

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

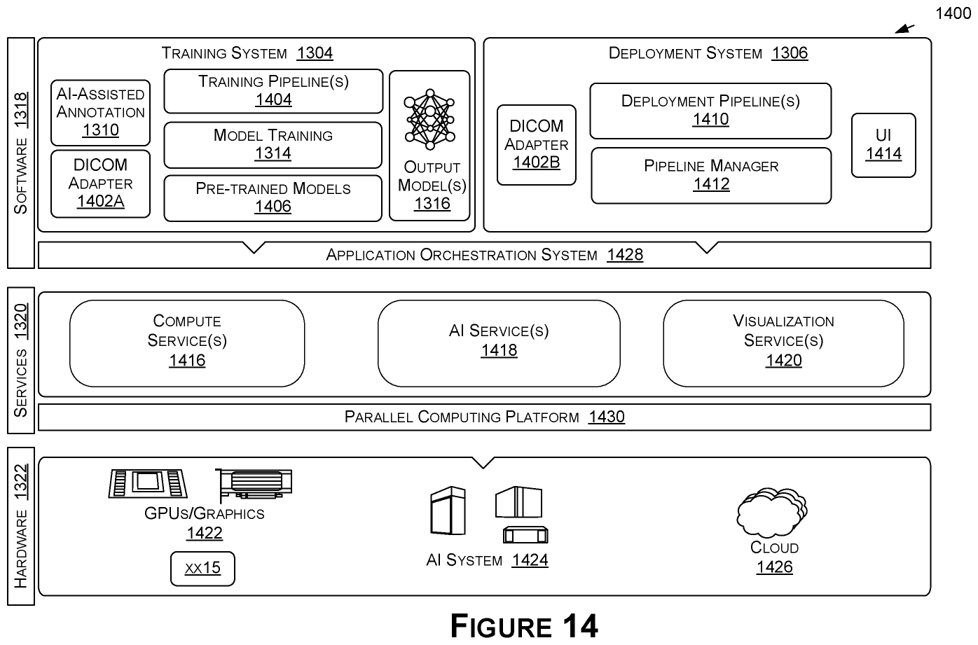

In at least one embodiment, model registry 1324 may be backed by object storage that may support versioning and object metadata. In at least one embodiment, object storage may be accessible through, for example, a cloud storage (e.g., cloud 1426 of FIG. 14) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1404 (FIG. 14) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled clinic data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline 1404 (FIG. 14) may include a scenario where facility 1302 requires a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled clinic data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. Services 1320 may include compute services, artificial intelligence (AI) services, visualization services, and/or other service types. Services 1320 may provide functionality that is common to one or more applications in software 1318, so functionality may be abstracted to a service that may be called upon or leveraged by applications. Functionality provided by services 1320 may run dynamically and more efficiently, while also scaling well by allowing applications to process data in parallel (e.g., using a parallel computing platform 1430 (FIG. 14)). In at least one embodiment, rather than each application that shares a same functionality offered by a service 1320 being required to have a respective instance of service 1320, service 1320 may be shared between and among various applications. In at least one embodiment, services 1320 may include (without limitation) an inference server or engine that may be used for executing detection or segmentation tasks, a model training service that provides machine learning model training and/or retraining capabilities, a data augmentation service that provides GPU accelerated data (e.g., DICOM, RIS, CIS, REST compliant, RPC, raw, etc.) extraction, resizing, scaling, and/or other augmentation, a visualization service adds image rendering effects—such as ray-tracing, rasterization, denoising, sharpening, etc.—to add realism to two-dimensional (2D) and/or three-dimensional (3D) models, and/or virtual instrument services that provide for beam-forming, segmentation, inferencing, imaging, and/or support for other applications within pipelines of virtual instruments.

In at least one embodiment, where a service 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may be implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipelines 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, labeled data 1312 (e.g., traditional annotation) may be generated by any number of techniques, such as within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipelines 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1410 depending on information desired from data generated by a device. In at least one embodiment, where detections of anomalies are desired from an MRI machine, there may be a first deployment pipeline 1410, and where image enhancement is desired from output of an MRI machine, there may be a second deployment pipeline 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipelines 1410 may be even more user friendly, provide for easier integration, and produce more accurate, efficient, and timely results.

In at least one embodiment, deployment system 1306 may include a user interface 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples (e.g., as illustrated in FIG. 12cc) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute services 1416, AI services 1418, visualization services 1420, and/or other service types. In at least one embodiment, applications may call (e.g., execute) one or more of services 1320 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation operation may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1306. GPUs 1422 (e.g., NVIDIA's TESLA and/or QUADRO GPUs) may include any number of GPUs that may be used for executing processing tasks of compute services 1416, AI services 1418, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). Cloud 1426, AI system 1424, and/or other components of system 1400 may use GPUs 1422. Cloud 1426 may include a GPU-optimized platform for deep learning tasks. AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

AI system 1424 may include a purpose-built computing system (e.g., a super-computer or an HPC) configured for inferencing, deep learning, machine learning, and/or other artificial intelligence tasks. AI system 1424 (e.g., NVIDIA's DGX) may include GPU-optimized software (e.g., a software stack) that may be executed using a plurality of GPUs 1422, in addition to CPUs, RAM, storage, and/or other components, features, or functionality. One or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. Cloud 1426 may include an AI system(s) 1424 for performing one or more of AI-based tasks of system 1400 (e.g., as a hardware abstraction and scaling platform). Cloud 1426 may integrate with application orchestration system 1428 leveraging multiple GPUs to enable seamless scaling and load balancing between and among applications and services 1320. Cloud 1426 may tasked with executing at least some of services 1320 of system 1400, including compute services 1416, AI services 1418, and/or visualization services 1420, as described herein. Cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

In sum, the disclosed techniques use probabilistic models to control the generation of synthetic speech data that includes (i) multi-speaker audio recordings and (ii) labels that specify speaker identities and start and end timestamps for individual utterances within the multi-speaker audio recordings. The probabilistic models are used in conjunction with parameters that characterize the occurrences of various speech-based attributes within the synthetic speech data. For example, these parameters may be used to determine a distribution of overlapping speech, a distribution of silence, and/or other distributions of speech-based attributes in the multi-speaker audio recordings. During the generation of a given synthetic multi-speaker recording, a discrepancy between the rate at which a given speech-based attribute occurs within an existing generated portion of a multi-speaker audio recording and an expected or “target” rate of the speech-based attribute within the multi-speaker audio recording is computed. This discrepancy is used to generate and sample from a distribution of amounts of the speech-based attribute to determine the amount of the speech-based attribute to be included in one or more subsequent generated portions of the same multi-speaker audio recording.

One technical advantage of the disclosed techniques relative to prior approaches is the ability to generate a diverse and accurately labeled set of data for the purposes of training and/or evaluating a machine learning model on speaker diarization and/or related tasks. Accordingly, the disclosed techniques may be used to overcome issues with privacy, data imbalance, diversity, and labeling overhead associated with collecting real-world speaker diarization data. Another technical advantage of the disclosed techniques is the ability to generate multi-speaker or multi-talker audio data that adheres to specific distributions of speech overlap, silence, and/or other speech-based attributes. Consequently, the disclosed techniques may be used to generate synthetic speech data that mimics real human dialogue more accurately than conventional multi-speaker or multi-talker data simulators. In turn, machine learning models that are trained and/or tested using this synthetic speech data may perform better on speaker diarization, voice activity detection, and/or other tasks than machine learning models that are trained and/or tested using data from conventional multi-speaker or multi-talker data simulators.
1. In some embodiments, a method comprises determining a first rate at which a first speech-based attribute occurs within a first portion of a simulated multi-speaker recording; computing a first difference between the first rate and a first target rate for the first speech-based attribute; determining, based at least on the first difference, a second rate at which the first speech-based attribute is to occur within a second portion of the simulated multi-speaker recording; and generating the second portion of the simulated multi-speaker recording based at least on the second rate.
2. The method of clause 1, further comprising determining a second difference between a third rate at which a second speech-based attribute occurs within the first portion of the simulated multi-speaker recording and a second target rate for the second speech-based attribute; and determining that the first difference exceeds the second difference prior to generating the second portion of the simulated multi-speaker recording.
3. The method of any of clauses 1-2, further comprising determining a second difference between a third rate at which a second speech-based attribute occurs within the first portion of the simulated multi-speaker recording and the second portion of the simulated multi-speaker recording and a second target rate for the second speech-based attribute; determining a third difference between a fourth rate at which the first speech-based attribute occurs within the first portion of the simulated multi-speaker recording and the second portion of the simulated multi-speaker recording and the first target rate for the second speech-based attribute; and generating a third portion of the simulated multi-speaker recording based at least on a comparison of the second difference and the third difference.
4. The method of any of clauses 1-3, wherein the generating the third portion of the simulated multi-speaker recording comprises determining that the second difference exceeds the third difference; and in response to determining that the second difference exceeds the third difference, generating the third portion of the simulated multi-speaker recording based at least on a fifth rate at which the second speech-based attribute is to occur within the third portion of the simulated multi-speaker recording.
5. The method of any of clauses 1-4, wherein the determining the second rate comprises at least one of computing the second rate based at least on a sampled value associated with the first speech-based attribute, an amount of the first speech-based attribute within the first portion of the simulated multi-speaker recording, or a running length associated with the first portion of the simulated multi-speaker recording.
6. The method of any of clauses 1-5, further comprising determining a speaker associated with the second portion of the simulated multi-speaker recording based at least on a turn probability associated with the simulated multi-speaker recording.
7. The method of any of clauses 1-6, wherein the generating the second portion of the simulated multi-speaker recording comprises generating a distribution of amounts of the first speech-based attribute based at least on the second rate for the first speech-based attribute; sampling an amount of the first speech-based attribute from the distribution; and adding the amount of the first speech-based attribute to the second portion of the simulated multi-speaker recording.
8. The method of any of clauses 1-7, further comprising determining the first target rate based at least on a set of parameters associated with generating the simulated multi-speaker recording.
9. The method of any of clauses 1-8, wherein the determining the first target rate comprises converting the set of parameters into a first distribution associated with the first speech-based attribute; sampling a mean of a second distribution of rates for the first speech-based attribute from the first distribution; and computing the first target rate based at least on the mean.
10. The method of any of clauses 1-9, wherein the first speech-based attribute comprises at least one of an overlap in speech or a silence.
11. In some embodiments, one or more processors comprise one or more circuits to perform operations comprising determining a first rate at which a first speech-based attribute occurs within a first portion of a simulated multi-speaker recording; computing a first difference between the first rate and a first target rate for the first speech-based attribute; determining, based at least on the first difference, a second rate at which the first speech-based attribute is to occur within a second portion of the simulated multi-speaker recording; and generating the second portion of the simulated multi-speaker recording based at least on the second rate.
12. The one or more processors of clause 11, wherein the operations further comprise determining a second difference between a third rate at which a second speech-based attribute occurs within the first portion of the simulated multi-speaker recording and a second target rate for the second speech-based attribute; and determining that the first difference exceeds the second difference prior to generating the second portion of the simulated multi-speaker recording.
13. The one or more processors of any of clauses 11-12, wherein the operations further comprise determining a second difference between a third rate at which a second speech-based attribute occurs within the first portion of the simulated multi-speaker recording and the second portion of the simulated multi-speaker recording and a second target rate for the second speech-based attribute; determining a third difference between a fourth rate at which the first speech-based attribute occurs within the first portion of the simulated multi-speaker recording and the second portion of the simulated multi-speaker recording and the first target rate for the second speech-based attribute; determining that the second difference exceeds the third difference; and in response to determining that the second difference exceeds the third difference, generating a third portion of the simulated multi-speaker recording based at least on a fifth rate at which the second speech-based attribute is to occur within the third portion of the simulated multi-speaker recording.
14. The one or more processors of any of clauses 11-13, wherein the first speech-based attribute comprises an overlap in speech and the second speech-based attribute comprises a silence.
15. The one or more processors of any of clauses 11-14, wherein the determining the second rate comprises computing the second rate based at least on a sampled mean for the first speech-based attribute, an amount of the first speech-based attribute within the first portion of the simulated multi-speaker recording, and a running length associated with the first portion of the simulated multi-speaker recording.
16. The one or more processors of any of clauses 11-15, wherein the generating the second portion of the simulated multi-speaker recording comprises generating a distribution of amounts of the first speech-based attribute based at least on the second rate for the first speech-based attribute; sampling an amount of the first speech-based attribute from the distribution; and adding the amount of the first speech-based attribute to the second portion of the simulated multi-speaker recording.
17. The one or more processors of any of clauses 11-16, further comprising sampling the first target rate from a distribution associated with a set of parameters for generating the simulated multi-speaker recording.
18. The processor of any of clauses 11-17, wherein the one or more processors are comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system for generating synthetic data; a system for performing one or more generative AI applications; a system incorporating one or more virtual machines (VMs); a system implemented at least partially in a data center; or a system implemented at least partially using cloud computing resources.
19. In some embodiments, a system comprises one or more processing units to perform operations comprising determining a first rate at which a first speech-based attribute occurs within a first portion of a simulated multi-speaker recording; computing a first difference between the first rate and a first target rate for the first speech-based attribute; determining, based at least on the first difference, a second rate at which the first speech-based attribute is to occur within a second portion of the simulated multi-speaker recording; and generating the second portion of the simulated multi-speaker recording based at least on the second rate.
20. The system of clause 19, wherein the system is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system for generating synthetic data; a system for performing one or more generative AI applications; a system incorporating one or more virtual machines (VMs); a system implemented at least partially in a data center; or a system implemented at least partially using cloud computing resources.

It should be noted that, while example embodiments described herein may relate to a CUDA programming model, techniques described herein may be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that may be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU may refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data may be accomplished in a variety of ways such as by receiving data as a parameter of a function call or a call to an application programming interface. In at least one embodiment, processes of obtaining, acquiring, receiving, or inputting analog or digital data may be accomplished by transferring data via a serial or parallel interface. In at least one embodiment, processes of obtaining, acquiring, receiving, or inputting analog or digital data may be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data may be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
determining a first rate at which a first speech-based attribute occurs within a first portion of a simulated multi-speaker recording;
computing a first difference between the first rate and a first target rate for the first speech-based attribute;
determining, based at least on the first difference, a second rate at which the first speech-based attribute is to occur within a second portion of the simulated multi-speaker recording; and
generating the second portion of the simulated multi-speaker recording based at least on the second rate.

2. The method of claim 1, further comprising:
determining a second difference between a third rate at which a second speech-based attribute occurs within the first portion of the simulated multi-speaker recording and a second target rate for the second speech-based attribute; and
determining that the first difference exceeds the second difference prior to generating the second portion of the simulated multi-speaker recording.

3. The method of claim 1, further comprising:
determining a second difference between a third rate at which a second speech-based attribute occurs within the first portion of the simulated multi-speaker recording and the second portion of the simulated multi-speaker recording and a second target rate for the second speech-based attribute;
determining a third difference between a fourth rate at which the first speech-based attribute occurs within the first portion of the simulated multi-speaker recording and the second portion of the simulated multi-speaker recording and the first target rate for the second speech-based attribute; and
generating a third portion of the simulated multi-speaker recording based at least on a comparison of the second difference and the third difference.

4. The method of claim 3, wherein the generating the third portion of the simulated multi-speaker recording comprises:
determining that the second difference exceeds the third difference; and
in response to determining that the second difference exceeds the third difference, generating the third portion of the simulated multi-speaker recording based at least on a fifth rate at which the second speech-based attribute is to occur within the third portion of the simulated multi-speaker recording.

5. The method of claim 1, wherein the determining the second rate comprises at least one of computing the second rate based at least on a sampled value associated with the first speech-based attribute, an amount of the first speech-based attribute within the first portion of the simulated multi-speaker recording, or a running length associated with the first portion of the simulated multi-speaker recording.

6. The method of claim 1, further comprising determining a speaker associated with the second portion of the simulated multi-speaker recording based at least on a turn probability associated with the simulated multi-speaker recording.

7. The method of claim 1, wherein the generating the second portion of the simulated multi-speaker recording comprises:
generating a distribution of amounts of the first speech-based attribute based at least on the second rate for the first speech-based attribute;
sampling an amount of the first speech-based attribute from the distribution; and
adding the amount of the first speech-based attribute to the second portion of the simulated multi-speaker recording.

8. The method of claim 1, further comprising determining the first target rate based at least on a set of parameters associated with generating the simulated multi-speaker recording.

9. The method of claim 8, wherein the determining the first target rate comprises:
converting the set of parameters into a first distribution associated with the first speech-based attribute;
sampling a mean of a second distribution of rates for the first speech-based attribute from the first distribution; and
computing the first target rate based at least on the mean.

10. The method of claim 1, wherein the first speech-based attribute comprises at least one of an overlap in speech or a silence.

11. One or more processors comprising:
one or more circuits to perform operations comprising:
determining a first rate at which a first speech-based attribute occurs within a first portion of a simulated multi-speaker recording;
computing a first difference between the first rate and a first target rate for the first speech-based attribute;
determining, based at least on the first difference, a second rate at which the first speech-based attribute is to occur within a second portion of the simulated multi-speaker recording; and
generating the second portion of the simulated multi-speaker recording based at least on the second rate.

12. The one or more processors of claim 11, wherein the operations further comprise:
determining a second difference between a third rate at which a second speech-based attribute occurs within the first portion of the simulated multi-speaker recording and a second target rate for the second speech-based attribute; and
determining that the first difference exceeds the second difference prior to generating the second portion of the simulated multi-speaker recording.

13. The one or more processors of claim 11, wherein the operations further comprise:
determining a second difference between a third rate at which a second speech-based attribute occurs within the first portion of the simulated multi-speaker recording and the second portion of the simulated multi-speaker recording and a second target rate for the second speech-based attribute;
determining a third difference between a fourth rate at which the first speech-based attribute occurs within the first portion of the simulated multi-speaker recording and the second portion of the simulated multi-speaker recording and the first target rate for the second speech-based attribute;
determining that the second difference exceeds the third difference; and
in response to determining that the second difference exceeds the third difference, generating a third portion of the simulated multi-speaker recording based at least on a fifth rate at which the second speech-based attribute is to occur within the third portion of the simulated multi-speaker recording.

14. The one or more processors of claim 13, wherein the first speech-based attribute comprises an overlap in speech and the second speech-based attribute comprises a silence.

15. The one or more processors of claim 11, wherein the determining the second rate comprises computing the second rate based at least on a sampled mean for the first speech-based attribute, an amount of the first speech-based attribute within the first portion of the simulated multi-speaker recording, and a running length associated with the first portion of the simulated multi-speaker recording.

16. The one or more processors of claim 11, wherein the generating the second portion of the simulated multi-speaker recording comprises:
generating a distribution of amounts of the first speech-based attribute based at least on the second rate for the first speech-based attribute;
sampling an amount of the first speech-based attribute from the distribution; and
adding the amount of the first speech-based attribute to the second portion of the simulated multi-speaker recording.

17. The one or more processors of claim 11, further comprising sampling the first target rate from a distribution associated with a set of parameters for generating the simulated multi-speaker recording.

18. The processor of claim 11, wherein the one or more processors are comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system for generating synthetic data;
a system for performing one or more generative AI applications;
a system incorporating one or more virtual machines (VMs);
a system implemented at least partially in a data center; or
a system implemented at least partially using cloud computing resources.

19. A system comprising:
one or more processing units to perform operations comprising:
determining a first rate at which a first speech-based attribute occurs within a first portion of a simulated multi-speaker recording;
computing a first difference between the first rate and a first target rate for the first speech-based attribute;
determining, based at least on the first difference, a second rate at which the first speech-based attribute is to occur within a second portion of the simulated multi-speaker recording; and
generating the second portion of the simulated multi-speaker recording based at least on the second rate.

20. The system of claim 19, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system for generating synthetic data;
a system for performing one or more generative AI applications;
a system incorporating one or more virtual machines (VMs);
a system implemented at least partially in a data center; or
a system implemented at least partially using cloud computing resources.
